(19) United States
(12) Patent Application Publication
(10) Pub. No.: US 2025/0148048 A1
(43) Pub. Date: May 8, 2025

(54) METHOD AND DEVICE FOR OPTICAL CONVOLUTION

(71) Applicant: Research Foundation of the City University of New York, New York, NY (US)

(72) Inventors: Mohammad Ali Miri, Plainview, NY (US); Kevin Dagoberto Zelaya Mendoza, Kew Gardens, NY (US)

(21) Appl. No.: 18/935,290

(22) Filed: Nov. 1, 2024

Related U.S. Application Data
(60) Provisional application No. 63/595,409, filed on Nov. 2, 2023.

(51) Int. Cl. G06F 17/15; G06E 3/00

(52) U.S. Cl. CPC G06F 17/156; G06E 3/005

(57) ABSTRACT

A photonic circuit comprises a first waveguide lattice having a first length for providing a discrete fractional Fourier transform operation on the input optical signal; a programmable modular array of tunable phase shifters for providing the fractional Fourier transform of the kernel and performing a point-wise product on the previously transformed input optical signal; a second wavelength lattice having a second length for providing an inverse discrete fractional Fourier transform operation on the previous processed optical signal; and a processor that determines a convolved output of the input signal and the convolution kernel.

### RELATED APPLICATIONS

This application claims priority to U.S. Provisional Application Ser. No. 63/595,409 filed Nov. 2, 2023 entitled “Method and Device for Optical Convolution and Convolution Filters on Chip,” the entirety of which is incorporated by reference herein.

### STATEMENT REGARDING FEDERALLY FUNDED RESEARCH FOR DEVELOPMENT

The government has certain rights in the invention. This invention was made with government support under grant number FA9550-22-1-0189 awarded by the United States Air Force Office of Scientific Research (AFOSR). This invention was also made with government support under grant number FA9550-23-1-0539 awarded by the Defense University Research Instrumentation Program (DURIP). The government has certain rights in the invention.

### FIELD

The present concepts relate generally to optical convolution processing, and more specifically to a lens-free apparatus implemented according to an integrated photonic circuit architecture that performs optical convolution processing operations based on a discrete Fractional Fourier transform (DFrFT).

### BACKGROUND

Convolution is a well-known mathematical operation on two functions that produce a result function, which is an integral of the product of the two functions after one function is reflected about the y-axis, or reversed and shifted. The integral is evaluated for all values of shift, producing the convolution function. Similar results are held with discretized signals.

Convolution is used in signal processing which is core to various filtering tasks. By convolving a signal with a filter or kernel, one can identify patterns, detect edges, and remove noise, making it an essential tool in many applications such as image and audio processing and digital signal processing. Since the introduction of convolutional neural networks, which have been largely successful in various applications, convolution has gained further interest as one of the most important processes for feature extraction in deep learning.

In optics, since the early days of optical signal processing, there has been great interest in optically performing convolution operations. For example, in free space optics, high-dimensional convolution is readily performed in the Fourier domain by using the so-called 4f optical system that utilizes two lenses for performing a discrete Fourier transform (DFT) and the inverse operation on spatially modulated light wavefront, while the kernel is encoded using electronically-controllable spatial light modulating devices.

In integrated photonics, convolution has been performed in the form of a matrix-vector multiplication. In some applications, wavelength-division multiplexing is implemented to encode information in different colors. However, the on-chip realization of a convolution operator in the Fourier domain has remained challenging, given the lack of a compact integrated DFT unit. In addition, the use of bulky lenses and pre-manufactured convolution layers in optical convolution implementations can cause numerous issues, from feasibility to scalability due to noise and space limitations.

### SUMMARY

In one aspect, a photonic circuit comprises a first waveguide lattice having a first length for providing a discrete fractional Fourier transform operation on the input optical signal; a programmable modular array of tunable phase shifters for providing the fractional Fourier transform of the kernel and performing a point-wise product on the previously transformed input optical signal; a second wavelength lattice having a second length for providing an inverse discrete fractional Fourier transform operation on the previous processed optical signal; and a processor that determines a convolved output of the input signal and the convolution kernel.

In some embodiments, the first waveguide lattice includes a photonic Jx lattice to perform the discrete fractional Fourier transform operation.

In some embodiments, the first waveguide lattice and the second waveguide lattice include a plurality of non-uniform spaced waveguides that renders an equally spaced spectra.

In some embodiments, the programmable modular array is constructed and arranged as an interlaced configuration so that a required fractional convolution operation is performed.

In some embodiments, the discrete fractional Fourier transformation performed one the at least one of the convolution kernel and the input signal has a first predetermined order (a) defined by a lattice length through a propagation direction, and the final discrete fractional Fourier transformation layer has a second order (2π-α).

In some embodiments, the photonic circuit is implemented in a displacement filter.

In some embodiments, the photonic circuit is implemented in a smoothing filter.

In some embodiments, the photonic circuit is implemented in an edge-detection filter.

In another aspect, a lens-free device for performing discrete fractional Fourier transformation (DFrFT) comprises a first waveguide array with a length of \tilde{k}π/2 that is optically connected to a programmable array of Mach-Zehnder interferometers (MZI), each MZI having two 50:50 couplers and two programmable phase shifters, each MZI interferometer optically connected to a second waveguide array with a length of 3\tilde{k}π/2.

In some embodiments, the first waveguide array, the physical waveguide array 1206, performs the DFrFT on an input signal, and wherein the MZIs encode a transformed kernel, which is processed with the input signal in a point-wise operation.

In some embodiments, the lens-free device further comprises grating couplers attached as input and output ports for performing light coupling operations.

In some embodiments, the first waveguide array includes a photonic Jx lattice to perform the DFrFT operation.

In some embodiments, the lens-free device is implemented in a displacement filter.

In some embodiments, the lens-free device is implemented in a smoothing filter.

In some embodiments, the lens-free device is implemented in an edge detection filter.

In another aspect, a method comprises receiving an input signal at a first input of a system; receiving a convolution kernel at a second input of the system; producing a discrete fractional Fourier transformation of at least one of the convolution kernel and the input signal; and generating a convolved output at an output of the system.

In some embodiments, the method further comprises performing a point wise multiplication operation of the input signal and the convolution kernel; and outputting an output of the multiplication operation to a final discrete fractional Fourier transformation layer to generate a convolved output.

In some embodiments, the discrete fractional Fourier transformation performed one the at least one of the convolution kernel and the input signal has a first predetermined order (a) defined by a lattice length through a propagation direction, and the final discrete fractional Fourier transformation layer has a second order (2π-α).

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention. In the drawings:

FIG. 1 is a block diagram of a system performing a convolution using the discrete fractional Fourier transform (DFrFT), in accordance with some embodiments of the present inventive concept.

FIG. 2 is a is a schematic diagram an integrated photonic circuit for a DFrFT-based convolution accelerator of an integrated photonic device, in accordance with some embodiments.

FIGS. 3A-3D are graphs of a fractional convolution for a displacement filters and specific field mode profiles, in accordance with some embodiments.

FIG. 4 is graph of a continuous interpolation of a distance function, in accordance with some embodiments.

FIGS. 5A-5D are graphs illustrating an output result of a convolution of eigenmodes, in accordance with some embodiments.

FIG. 6 is a graph illustrating a convolution curve for a noisy signal generated according to some embodiments.

FIG. 7 is a graph illustrating an input signal and the corresponding convolution comparing edge-detection filters for a waveguide array, in accordance with some embodiments.

FIG. 8 is a graph of an edge-detection scheme with a noisy signal, in accordance with some embodiments.

FIG. 9A is a view of an electric field modulus propagating through a convolution system, in accordance with some embodiments.

FIG. 9B is a graph illustrating input and output field amplitudes of simulated results.

FIG. 9C is a graph illustrating theoretical predictions from a coupled-mode theory.

FIG. 10 is a graph illustrating mean and standard deviation of the relative percent error for a set of 100 randomly generated perturbed DFrFT matrices, in accordance with some embodiments.

FIGS. 11A and 11B are graphs of a distance function between unperturbed and perturbed convolution operations using u^{(j-1)} (see definition below) and double-box filters, in accordance with some embodiments.

FIG. 12 is a schematic view of a photonic integrated circuit (PIC) layout, in accordance with some embodiments.

FIG. 13 is a table of a set of example convolution scheme parameters used to produce an output of a convolution, in accordance with some embodiments.

### DETAILED DESCRIPTION

There is a desire for performing convolution on-chip by utilizing multimode interference in broad-area waveguides with large footprints to approximate the DFT operation. The fractional Fourier transform (FrFT) was first introduced by V. Namias, in “The Fractional Order Fourier Transform and Its Application to Quantum Mechanics,” IMA Journal of Applied Mathematics, 1980, the contents of which are incorporated by reference in their entirety as a way to extend the conventional Fourier transform for studying the dynamics of free and forced quadratic systems in quantum mechanics. Since its conception, it has been the subject of extensive research due to its potential applications in areas like signal processing and optics, including optimal filtering and time-frequency analysis. Despite its usefulness, the FrFT does not straightforwardly inherit all the desired mathematical properties of the Fourier transform (FT), namely, the translation invariance, correlation, and convolution of signals.

In brief overview, embodiments of the present inventive concept include a system, device, and method designed for optical information processing. Through theoretical analysis, numerical estimations, and wave simulations, the system and method are efficient in performing a wide range of optical tasks, including filtering, smoothing, and shape detection. Additionally, its programmable nature ensures versatility, enabling the implementation of other filtering and processing tasks with ease. The device is robust and resilient to mild manufacturing defects. Fabrication errors do not jeopardize the integrity of the device's operation.

In some embodiments, the system, device, and method, based on compact waveguide arrays, can perform optical processing without the need for lenses, substantially reducing the device's size and making it suitable for large-scale applications. The overall dynamics of the waveguide arrays are appropriate enough, as numerically estimated, for effective optical processing. There is a plethora of research available in the literature about the theoretical properties of fractional convolution transformations, but physical implementations in the context of optical devices are scarce.

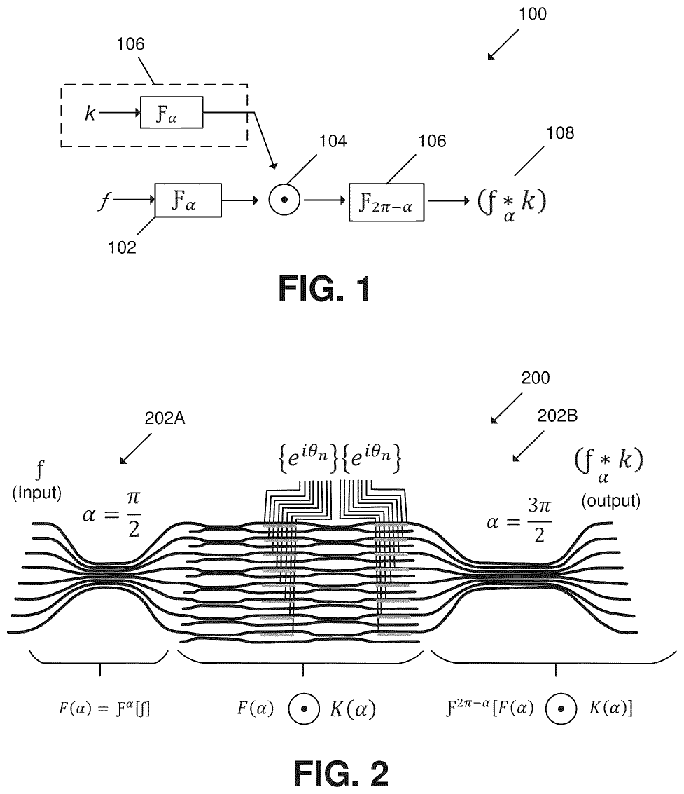

In some embodiments, the system, device, and method rely on a modified convolution operation based on a discrete Fractional Fourier transform (DFrFT), implemented in a simple photonic circuit involving only waveguides and modulator arrays, for example, shown in FIG. 1. Applications may include but not be limited to signal processing, time-frequency analysis, and pattern recognition. In some embodiments, a photonic Jx lattice is used as the generator of the DFrFT operation, for example, described in S. Weimann, A. Perez-Leija, M. Lebugle, R. Keil, M. Tichy, M. Grafe, R. Heilmann, S. Nolte, H. Moya-Cessa, G. Weihs, D. N. Christodoulides, and A. Szameit, “Implementation of quantum and classical discrete Fractional Fourier transforms,” Nature Communications 7, 11027 (2016), M. Honari-Latifpour, A. Binaie, M. A. Eftekhar N. Madamopoulos, and M.-A. Miri, “Arrayed waveguide lens for beam steering,” Nanophotonics 11, 3679 (2022), and K. Tschernig, R. de J. Le′on-Montiel, O. S. M. na Loaiza, A. Szameit, K. Busch, and A. Perez-Leija, “Multiphoton discrete Fractional Fourier dynamics in waveguide beamsplitters,” J. Opt. Soc. Am. B 35, 1985 (2018), the entirety of each of which is incorporated by reference herein. In contradistinction to the DFT, which relies on bulky lens setups that compromise its scalability, the Jx photonic lattice is reasonably easy to fabricate through open-access foundries and can be built up in a relatively small chip-scale setup. Furthermore, for large input ports, the DFrFT converges to the continuous FT for the appropriate length, and thus any operation involving the DFrFT is expected to converge to that of the FT, including the convolution operation. This establishes a comparison point for the results obtained from the embodiments of the present inventive concept and those expected from a conventional convolution scheme.

### Fractional Convolution

Fractional convolution considers the vectors f=(f₋ⱼ, . . . , fⱼ)^{T}∈ [symbol] ^{N} and k=(k₋ⱼ . . . , kⱼ)^{T}∈ [symbol] ^{N}, where

$$N = 2 j + 1 , j ∈ {ℤ}^{+} ⋃ ( ℤ + \frac{1}{2} ) .$$

and f^{T} stands for the matrix transposition. The convolution of f and k, henceforth considered as the input signal and convolution kernel, respectively, is defined as (f*k)ₚ=Σ_{q}f_{q}k_{p-q}. In other embodiments, the latter can be rewritten in terms of the discrete Fourier transform (DFT) of the aforementioned vectors, [symbol] [f]=F and [symbol] [k]=K. This allows rewriting the convolution operation as √N [symbol] [f*k]=F⊙K=(F₋ⱼK₋ⱼ, . . . , FⱼKⱼ)^{T} with ⊙ denoting the pointwise vector multiplication or Hadamard product, or binary operation that processes two matrices of the same dimensions and returns a matrix of the multiplied corresponding elements (different than a matrix product). The DFT is defined by the matrix multiplication [symbol] [f]≡ [symbol] f, with the matrix elements [symbol] _{p,q}=e^{-2iπ(pq/N)}/√N. The convolution is then recovered by performing the inverse DFT. Although mathematically equivalent, the latter form is more convenient for physical applications as the Fourier transform (FT) can be implemented using a conventional lens configuration.

The latter construction above implements an analogous setup based on the proper discrete fractional Fourier transform (DFrFT) and its asymptotic properties. Following the continuous fractional convolution proposed in D. Mendlovic and H. M. Ozaktas, “Fractional Fourier transforms and their optical implementation: I,” J. Opt. Soc. Am. A 10, 1875-1881 (1993) the entirety of which is incorporated by reference herein, the corresponding discrete counterpart of order α is defined as Equation (1):

$$√ N [ f * {}_{α} k ] = [ {ℱ}^{2 π - α} ( F ( α ) ⊙ K ( α ) ) ] . \qquad ( 1 )$$

where F(α):= [symbol] ^{α}[f] and K[α]: = [symbol] ^{α}[k] are the α-order discrete fractional Fourier transform (DFrFT) of f and k, respectively.

In some embodiments, a DFrFT according to Equation (1) can be manufactured in a compact on-chip device (e.g., in a cost-effective silicon-on-insulator platform) using photonic waveguide arrays (see FIG. 2), where the fractional order α is associated with the array length. In the limit of large arrays j→∞ and for channels such that q<<j, the DFrFT converges to the continuous FT. Although this limit case is unpractical for on-chip solutions, this establishes a benchmark to numerically compare the fractional convolution with the conventional one. In some embodiments, the Jx photonic lattice is used as the passive element in the architecture to perform the DFrFT operation. The wave evolution through such a lattice is based on the coupled-mode theory, defined in terms of the symmetric and tridiagonal tight-binding matrix Hamiltonian [symbol] , whose components are [symbol] _{p,q}=Kₚδ_{p+1,q}+Kₚ₋₁δ_{p-1,q}. In the latter, Kₚ=\tilde{k}\sqrt{(j−p)(j+p+1)/2} stands for the coupling parameter, whereas p, q E ∈{−j, . . . j} are waveguide numbers (channel), N=2j+1 the total number of waveguides in the array, and \tilde{k} a scaling factor henceforth fixed as the unity fir simplicity. The eigenvalue problem [symbol] u⁽ⁿ⁾=λₙu⁽ⁿ⁾ is well-known in the context of angular momentum in quantum mechanics, the eigenmodes (henceforth called supermodes interchangeably) and eigenvalues of which are:

$${u}_{q}^{( n )} = {2}^{q} \sqrt{\frac{( j + q ) ! ( j - q ) !}{( j + n ) ! ( j - n ) !}} {P}_{j + q}^{( n - q , - n - q )} ( 0 ) , {λ}_{n} = n ,$$

respectively, for \tilde{k}=1 and q, n ∈ {−j, . . . , j}. The upper-index n denotes the lattice eigenmode number (supermode), the lower-index q denotes the channel number, and Pₙ^{(a,b)}(z) denotes the Jacobi polynomials, according to F. Olver, D. Lozier, R. Boisvert, et al., NIST Handbook of Mathematical Functions (Cambridge University, 2010), the entirety of which is incorporated by reference herein.

Coupled-mode theory dictates the wave evolution of the electric field across a lattice, where the electric field takes the form E=(E₁, . . . , E_{N})^{T} as it propagates. Here, Eₚ is the individual guided mode at the p-th waveguide. Such propagation is ruled by the Schrödinger-like equation described in W.-P. Huang, “Coupled-mode theory for optical waveguides: an overview,” J. Opt. Soc. Am. A 11, 963-983 (1994) and. D. N. Christodoulides, F. Lederer, and Y. Silberberg, “Discretizing light behavior in linear and nonlinear waveguide lattices,” Nature 424, 817-823 (2003), the entirety of each of which is incorporated by reference herein, idE/dz= [symbol] E, where z is the propagation distance, and [symbol] is the aforementioned tight-binding Hamiltonian. Thus, the action of the unitary evolution operator

$$𝔾 ( z ) = {e}^{- i ℍ z} \qquad ( 2 )$$

on a given initial electric field E(z=0) generates the output field [symbol] (α)E(z=0)=E(z=α). The matrix components of evolution operator [symbol] write as stated in S. Weimann, et. al. “Implementation of quantum and classical discrete Fractional Fourier transforms,” the entirety of which is incorporated by reference herein.

The unitary operator [symbol] (α) clearly meets all the required properties for the DFrFT, that is, (i) unitarity, (ii) transformation-order additivity rule ( [symbol] ^{α}∘ [symbol] ^{β}) [f]= [symbol] ^{α+β}[f], and (iii) the existence of the cyclic index [symbol] ^{α=0}= [symbol] ^{α=2π}= [symbol] , with [symbol] the corresponding identity matrix in [symbol] ^{N}.

Although the latter properties may be considered the essential building blocks to define a DFrFT properly, additional conditions may be taken into account, such as the reduction to the continuous FT for infinitely many input ports, which is also the case for the Jx lattice in consideration. In some embodiments, the exponential form of the evolution operator is equivalent to the spectral decomposition; nevertheless, the opposite is not necessarily true. Indeed, the DFrFT introduced in C. Candan, M. A. Kutay, and H. M. Ozaktas, “The discrete fractional Fourier transform,” IEEE Trans. Signal Process. 48, 1329-1337 (2000), the entirety of which is incorporated by reference herein, is based on the spectral decomposition using the eigenvectors of a lattice Hamiltonian associated with the Harper equation. However, this is not related to the evolution of the Hamiltonian itself. Such a class of models is challenging for photonic implementations described in embodiments herein.

In some embodiments, the inverse order (−α) is implemented through the equivalent optical length 2π-α. Furthermore, following the cyclic property, the input signal spreads and reconstructs itself at α=2Mπ, for M ∈ Z_. The eigensolutions u⁽ⁿ⁾ converge in the limit N→∞ to the continuous Hermite-Gaussian modes, described in S. Weimann, et. al. “Implementation of quantum and classical discrete Fractional Fourier transforms,” incorporated by reference above. Consequently, [symbol] (α) converges to the FT for α=π/2 and j→∞, which can be used as a benchmark to test the outcome with respect to the conventional convolution.

### Photonic Implementation

FIG. 1 is a block diagram of a system 100 performing a convolution operation, in accordance with some embodiments of the present inventive concept. In some embodiments, the system 100 is implemented in an integrated photonic circuit.

In some embodiments, the system 100 includes three stages: (i) the input signal f for a first function 102 and the convolution kernel k for a first function 103 are transformed using a DFrFT of order α for each, (ii) such that the transformed signal and kernel are point-wise multiplied by a DFrFT operator 104 and (iii) finally inverse transformed through a final DFrFT layer 106 of order 2π-α to generate a convolved output (f*_{α}k) 108. The DFrFT operator 104 may be described by a unitary operator Eq. (2) above. The discrete fractional convolution operation represented by the system 100 may be defined by equation Eq. (1) above.

The fractional order α=π/2 allows for visualization of the involved steps in the photonic implementation. Non-classical light in a photonic lattice having parabolic coupling distribution such as a photonic Jx lattice may be implemented. For instance, a photonic Jx lattice of (normalized) length π/2 can perform the DFrFT transform on the input signal, rendering the required signal F(π/2) of step (i). The DFrFT transform of the kernel [K(π/2)] of step (i) and the pointwise multiplication of step (ii) can both be performed in a single step by introducing an array of N programmable Mach-Zehnder interferometers (MZIs) coupled to the end of the first Jx lattice. It is difficult to conduct a DFT through optical means. Therefore, a device implementing FIG. 1 can use a set of waveguide arrays to perform a DFrFT. The fractional order α of the DFrFT is defined by the lattice length through the propagation direction. In some embodiments, each MZI in the array comprises two 50:50 directional couplers and two programmable phase shifters ϕₙ and θₙ, with n ∈ {−j, . . . , j}, enabling both amplitude and phase modulation. More specifically, the combination and arrangement of phase shifters allows steering both the amplitude (attenuation) and phase of the input signal's component. Each N component of the device can be manipulated independently. Thus, the q-th component of the transformed input signal, F_{q}(π/2), transforms accordingly at the output as

$$\tilde{F} ( \frac{π}{2} ) := {e}^{i ( {ϕ}_{q} + {θ}_{q} + \frac{π}{2} )} sin ( \frac{{θ}_{q}}{2} ) {F}_{q} ( \frac{π}{2} ) .$$

Here, U_{DC}:=(σ₀−iσ₁)√2 is the operator characterizing the 50:50 directional couplers, with σj the conventional Pauli matrices. In this form, the phases θ_{q} and ϕ_{q} are tuned so that the complex-valued multiplicative factor

$${\tilde{F}}_{q} ( \frac{π}{2} )$$

renders the q-th component of the transformed kernel,

$${K}_{q} ( π / 2 ) = {e}^{i ( {ϕ}_{q} + {θ}_{q} + \frac{π}{2} )} sin ( \frac{{θ}_{q}}{2} ) .$$

Once this phase-tuning operation is performed across all the N channels, the required pointwise operation

$$F ( \frac{π}{2} ) ⊙ K ( \frac{π}{2} )$$

is ultimately achieved. Lastly, step (iii) is accomplished by coupling a final Jx lattice of length 3π/2 that performs the inverse transform operation.

Once the transformed kernel K(α) has been programmed, it can be used to sequentially analyze and extract the features of multiple signals f. Also, if the transformed kernel requires amplitude coefficients larger than one, it is always possible to rescale the kernel so that it can be programmed into the MZI array. The latter follows from Eq. (1), where it is clear that a global constant can be factored out of the architecture without modifying the convolution operation.

FIG. 2 is a schematic diagram of an integrated photonic circuit 200 for a DFrFT-based convolution accelerator of an optical device, in accordance with some embodiments. The architecture is based on waveguide coupling to achieve both the Jx lattice and the 50:50 directional coupler operations, whereas the phase manipulation can be performed by using either thermo-optical or phase-change material solutions, widely available on silicon-based platforms for production through open-access foundries.

In some embodiments, the photonic circuit 200 comprises two DFrFT lattices or waveguide arrays 202A, 202B having normalized lengths π/2 and 3π/2, respectively, and rendering the direct and inverse DFrFT of order α=π/2, respectively. The intermediate pointwise multiplication is performed through an array of programmable phase shifters. These are electrically tuned by the phase sets {e^{iθ}^{ₚ}} and {e^{iϕ}^{ₚ}} so that this layer performs K(α)= [symbol] ^{α}[k].

In some embodiments, the convolution architecture above is tested under various scenarios by programming different kernels with properties known in the conventional convolution case. This establishes a benchmark to test the performance of the current device and the results of the expected convolution. The operations considered are signal displacement, Gaussian filtering, and edge detection. Each of these cases is associated with a specific convolution kernel, and the test is performed with different signals, some including background noise to push forward the capabilities of the architecture.

One application of the photonic implementation in accordance with some embodiments includes a displacement filter. In some embodiments, a configuration considers the lattice eigenmodes u (n) as the signal input. These eigenmodes can be experimentally produced at the output of an additional photonic Jx lattice of length α=π/2 by exciting its n-th input channel. For instance, one generates a Gaussian-like distribution by exciting the j-th channel, which is the fundamental supermode and, from the oscillation theorem of Hermitian operators, described for example in A. F. Nikiforov and V. B. Uvarov, Special Functions of Mathematical Physics (Birkhäuser, 1988) the entirety of which is incorporated by reference herein is the only one with no oscillations, since oscillations in the discrete case are defined by their zero crossings. That is, a discrete function f has a zero-crossing at n if fnfn−1≤0. This is the only supermode with such behavior so that, in the continuous limit, it converges to a Gaussian distribution.

For the convolution kernel, we use a delta-like function k_{q}^{(δ,r)}=δ_{q,r}, with r ∈ {−j, . . . , j} and δ_{g,r} the Kronecker delta function. This is equivalent to exciting only the r-th convolution channel of the device. The straightforward calculations show that

$${K}_{p}^{( δ , r )} ( \frac{π}{2} ) := {( - i )}^{r - p} {u}_{p}^{( r )}$$

which shall be programmed into the MZI array of the architecture, and the corresponding DFrDT of the Gaussian-like input signal becomes Fₚ(π/2)=i^{j}uₚ^{(j)}). In some embodiments, the fractional convolution takes the form (f_{π/2}*k)=(−1)^{riq+r+j}[u₀^{(q)}u₀^{(j)}u₀^{(r)}+Σₚ₌₁^{j}uₚ^{(j)}(uₚ^{(q)}uₚ^{(r)}+u₋ₚ^{(q)}u₋ₚ^{(r)}](see the Convolution Expansion description below). For even j and following the parity symmetry of the Jx lattice eigenmodes, the convolution vanishes at the odd output channel if r is even; likewise, the output vanishes at the even channel for odd r. Furthermore, the roles are interchanged for odd j. For the sake of simplicity and without loss of generality, we henceforth focus only on even j. To avoid the latter partial suppression at the output, we can exploit the linearity of the convolution scheme Eq. (1) and alternatively use the convolution kernel k_{q}^{(δ}^{₂}^{,r)}=δ_{q,r}+δ_{q,r+1} composed of two consecutive delta-like signals so that both even and odd channels of u^{(j)} contribute to the convolution process.

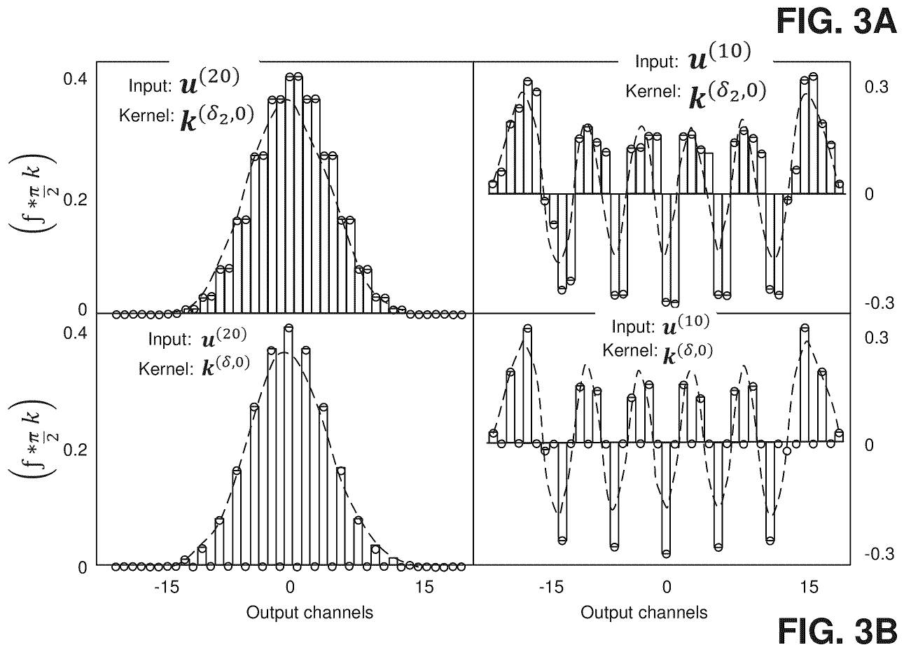

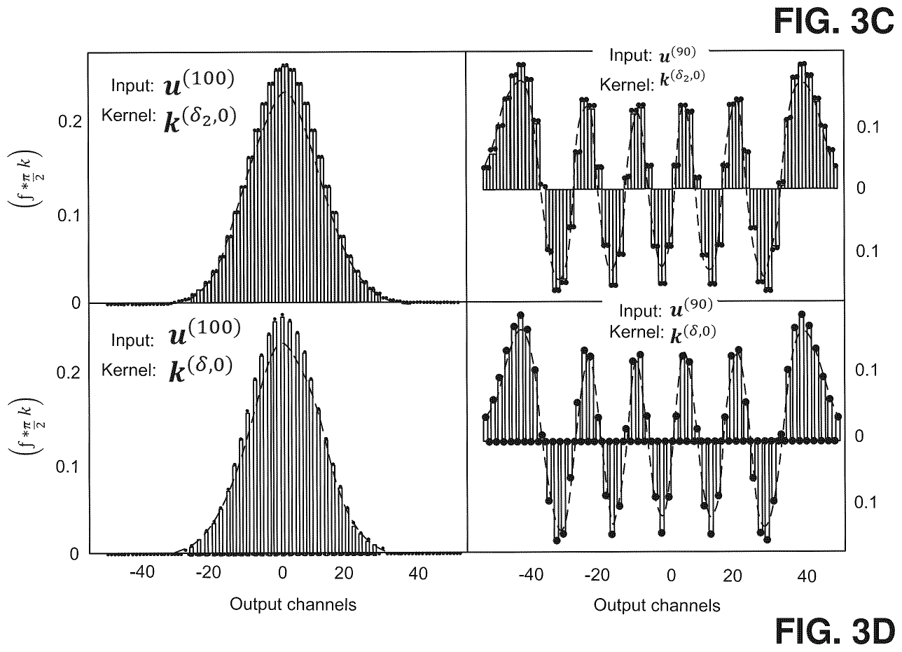

Further remarks can be obtained for more complex input functions. Since the set of eigenfunction {u⁽ⁿ⁾}ₙ₌₋ⱼ^{j} forms an orthonormal basis in [symbol] ^{2j+1}, any arbitrary input signal can be decomposed into the linear combination f=Σₘ₌₋ⱼ^{j} [symbol] ₘu^{(m)} [symbol] ₘ=[u^{(m)}]^{†}f with the corresponding expansion coefficients. For linear combinations of even (f_{-q}=f_{q}) or odd signals (f_{-q}=−f_{q}), the delta like convolution kernel produces an output exclusively on the even and odd channels, respectively. It is straightforward to note that the delta-like kernel k^{(δ,0)} in the conventional convolution (using the DFT) leaves the input signal unchanged, whereas the kernel k^{(δ,r)} displaces the signal by r units. This establishes a reference framework for the fractional convolution. To this end, 0 can be for the delta-like and double-delta kernel, combined with one of the eigenmodes u^{(s)} at the input. The eigenmode number s is fixed as s=20 and s=10 for j=20 so that we have nodeless and highly oscillatory signals at the input. For j=100, we use the corresponding modes, s=100, 90, that match the number of nodes of the previous case. The resulting fractional convolution is depicted in FIG. 3A-3D for j=20 and j=100, respectively, where the suppression at the odd channel of the output is evident for the delta-like kernel, as predicted. In turn, the double-delta kernel k^{(δ2, 0)} fixes the output suppression and leads to an output signal akin to the respective input eigenmode. To quantify any difference between the input and output, the distance function

$${d}_{y 1 , y 2} := ‖ {y}_{1} - {y}_{2} ‖ \qquad ( 3 )$$

is used, with ∥·∥ the Euclidean norm in [symbol] ^{2j+1}.

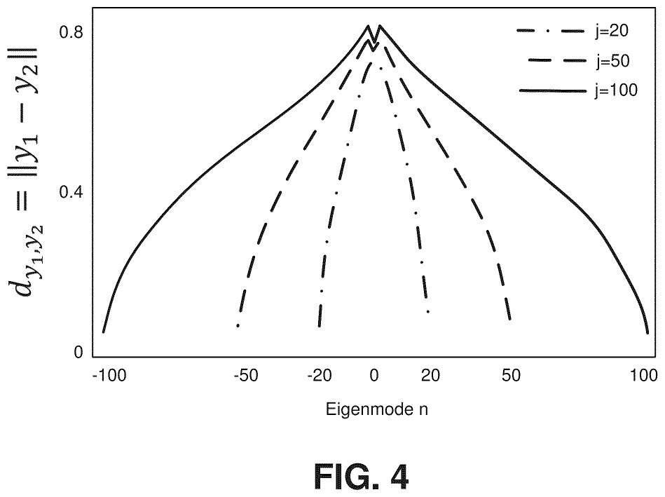

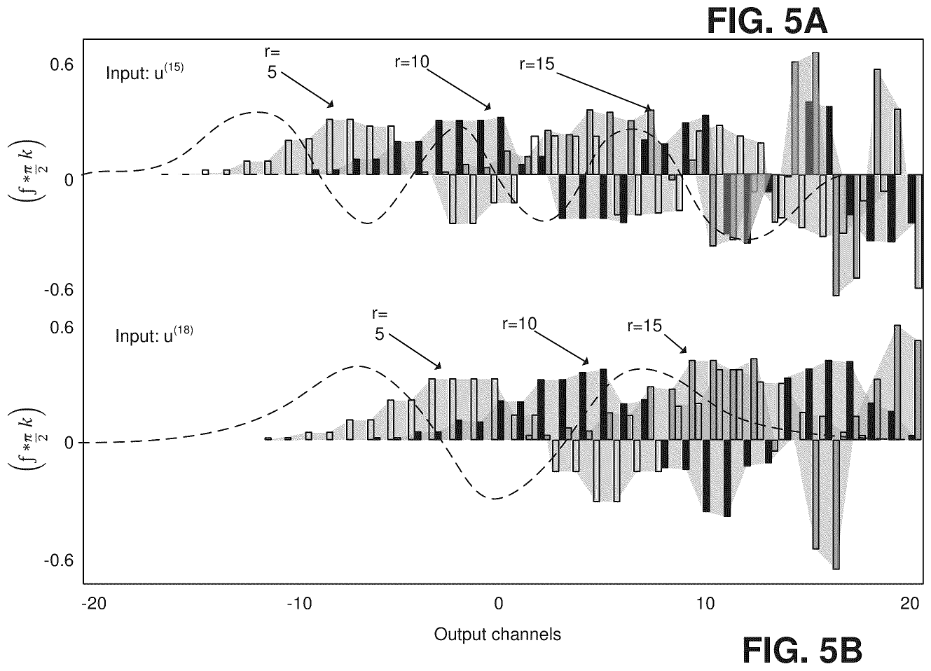

Here, y₁=u⁽ⁿ⁾ is the input eigenmode and y₂ the corresponding normalized convolution at the architecture output when the double-delta kernel k^{(δ2, 0)} is used. It is worth stressing that the convolution output has been normalized in order to obtain a meaningful comparison. The corresponding distance is smaller for j=100 as compared to j=20 for the lowest and highest eigenmodes n=j and n=−j, leading to a good fidelity at the output. This agrees with the corresponding convolution results presented in FIG. 4. On the other hand, the distance increases for eigenmodes at and around n=0, where more deviations are expected for j=100 compared to j=20.

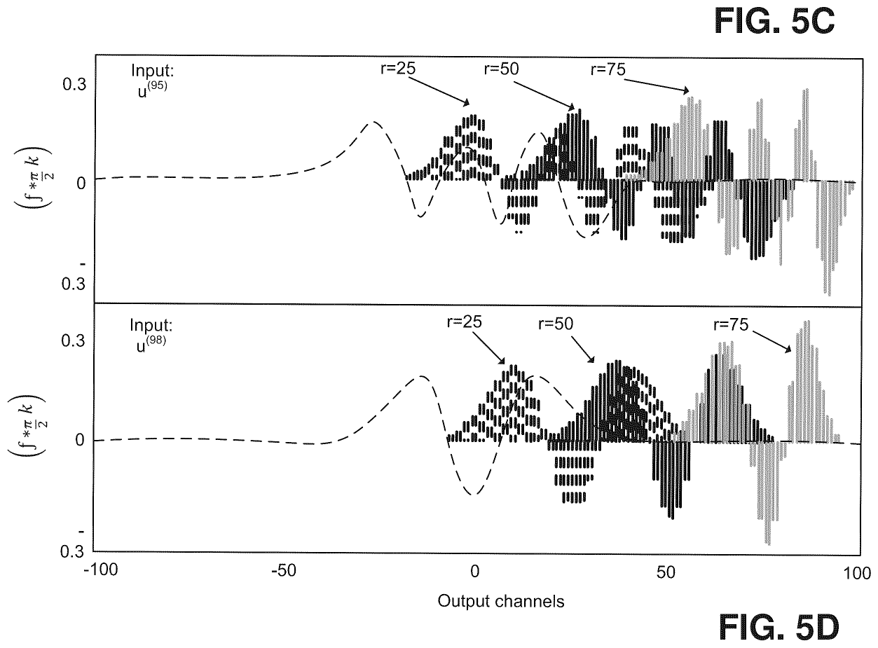

Once the fidelity of the convolution process with delta-like and double-delta kernels has been tested, we proceed to analyze the displacement produced by the kernel k^{(δ}^{₂}^{,r)}, with r≠0, where the double-delta function has been considered to avoid any channel suppression in the output. The effects of this kernel are tested for j=20 and displacements to the right amounting to 12.5% (r=5), 25% (r=10), and 37.5% (r=15) for the inputs u⁽¹⁸⁾ and u⁽¹⁵⁾. For both inputs, displacements of 12.5% and 25% produce an output that displaces without any major distortion, as the right tail of signals vanishes prior to reaching the lattice edge (see FIGS. 3A-3D). This is not the case with displacements of 37.5%, where the output becomes perturbed in channels near the edge. For j=100, we consider displacement kernels equivalent to those of the previous case, namely, 12.5% (r=25), 25% (r=50), and 37.5% (r=75), as well as inputs with the same number of oscillations, such as u⁽⁹⁸⁾ (two nodes) and u⁽⁹⁵⁾ (five nodes). FIGS. 5A-5D illustrates a resulting output, which exhibits only subtle distortions when subjected to 75% displacements. For eigenmodes with the same quantity of oscillations, the tail of both modes is larger than the scenario where j=20, which results in reduced edge effects leading to less interference at the edges.

Another application of the photonic implementation in accordance with some embodiments includes a Gaussian-like smoothing filter. In some embodiments, the u^{(j)} filter described above, and a discrete Gaussian filter are considered as testing kernels to analyze the output for a noisy signal composed by a rectangular window function with added background Gaussian noise. These two filters may be compared as follows. In order to take them to equal grounds, In doing so, discrete Gaussian filters are used with the same standard deviation of the corresponding u^{(j)} filter. For instance, for j=20, the standard deviation of u⁽ⁱ⁾ is σ≈3.1623. The corresponding discrete Gaussian filter with the same standard deviation and sampled in the same grid leads to a kernel indistinguishable from the first one. The difference between these two kernels can be quantified through the distance Eq. (3) herein. For j=20 and j=100, the distances are approximately 0.0111017 and 0.0010284, respectively, and become smaller for larger waveguide arrays. This reinforces the use of the filter u (as an alternative candidate for a Gaussian filter, which in turn can be generated from another Jx lattice with length α=π/2 by exciting the j-th input channel. Nevertheless, contrary to a Gaussian filter, the standard deviation of the filter u^{(j)} is fixed for each j and cannot be modified. This means that narrow or peaked signals might be suppressed during the process, and thus this filter is better suited for smoothing wide enough signals.

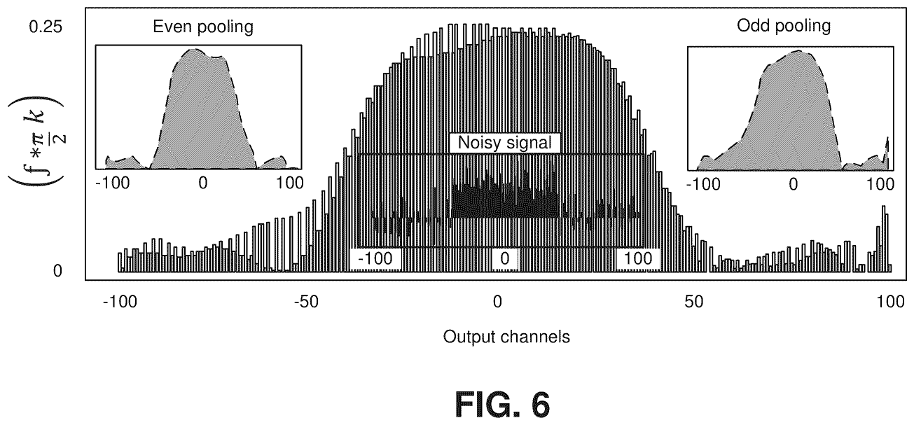

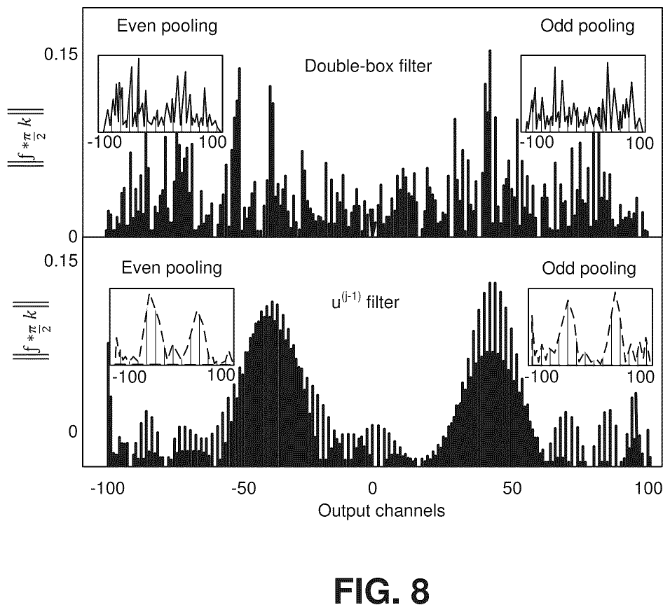

Let the input signal f composed of a rectangular window with added Gaussian noise and the Gaussian-like filter u^{(j)} be the inputs for our convolution device. We focus on the case j=100 so that each DFrFT element in the device approximates the conventional DFT, and thus results close to the conventional convolution are expected. The output of the latter is depicted in FIG. 6 where the noisy input signal is also shown for reference. FIG. 8 illustrates that the proposed convolution solution performs the intended smoothing process while averaging the initial noise. More specifically, the modulus of the convolved signal resulting from using the u^{(j)} filter with a noisy signal f (lower inset), composed of a rectangular window plus Gaussian noise for j=100, is depicted in FIG. 8. The upper-left and upper-right insets depict the even and odd pooling, respectively, associated with the convolution output. In this form, the hidden rectangular window inside the noise is still readable in the processed output. Still, the output contains noise that is inherently introduced from the Jx photonic lattice. As discussed above, any signal and convolution kernel lead to an output that splits into the even and odd channels, depending on the parity of j. This classification at the output reveals that an additive term exists in the even output that is not present on the odd one, or vice versa, depending on the parity of j and the input signal f (see the Convolution Expansion description below).

In filtering processes, it is common to introduce the notion of pooling layers, in which the effects of some filtering procedures are sharpened by splitting the sampling space into subgroups and performing specific operations on the latter. As a result, the sampling space of the output of the pooling layer is smaller than the original output. This is particularly common in convolutional neural networks, where the pooling process depends on the intended task at hand, such as minimum, maximum, and average pooling. For example, for maximum pooling, the N=2 m dimensional output is decomposed into m sub-groups, each of dimension two, where only the maximum number within each sub-group is preserved. Here, The even and odd pooling is introduced where an operation consists of splitting the output signal into its even (2q) and odd channels (2q+1). That is, for even pooling, only the information of the output channels 2q is analyzed, and likewise for the odd pooling. Although the resulting sampling space is half of the original output, the previously described noisy behavior is suppressed. This is particularly illustrated in the upper insets in FIG. 6.

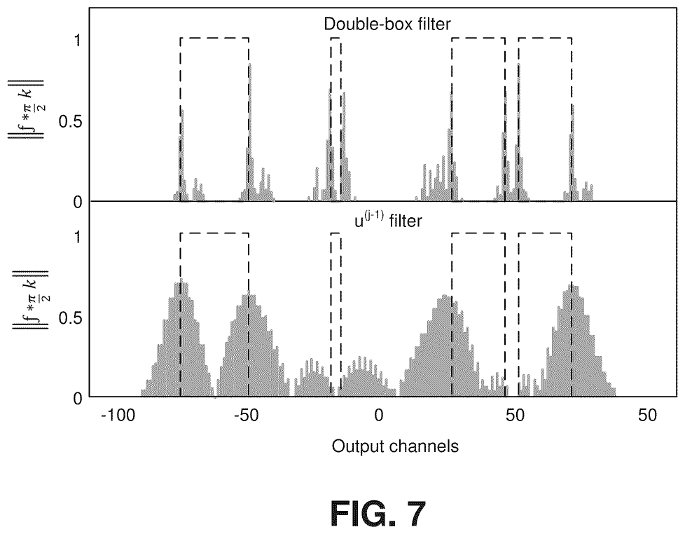

Another application of the photonic implementation in accordance with some embodiments includes an edge detection filter Although a large variety of edge detection filters exist, the general idea behind them lies in the smoothing of the signal and the gradient of the same. Smoothing is necessary to avoid unnecessary abrupt changes or singularities of step-like signals. For each smoothing filter, one may associate an edge detection scheme, which might or not be suitable for the signal in question. For the conventional convolution, it is quite a straightforward fact that the differentiation operator commutes with the convolution operation. This means that, instead of determining the gradient of the filtered signal, one can, in principle, compute the convolution using the gradient of the filter kernel instead. This simplifies the complexity of the edge detection scheme. The Gaussian derivative, the first Hermite-Gaussian mode, becomes the most natural edge detection filter as it comprises the Gaussian filtering and the gradient operation required for edge detection. Other alternatives include such as the Canny and Laplacian filters, described in J. Canny, “A computational approach to edge detection,” IEEE Trans. Pattern Anal. Mach. Intell. PAMI-8, 679-698 (1986) and J. W. Woods, Image Enhancement and Analysis, 2nd ed. (Academic, 2012), respectively, the contents of each of which are incorporated by reference in their entirety. In the system according to embodiments of the present invention, the eigenmode u^{(j-1)} becomes the natural candidate for the edge detection kernel as it converges to a first-order Hermite-Gaussian mode in the continuous limit. This can be easily generated by exciting the (j−1)-th input of a Jx photonic lattice of length π/2 (see FIG. 7). One of the drawbacks of such a filter is the lack of control over its width, which limits edge detection in narrow signals. We thus consider the double box (Canny edge), kernel k^{(c)}=−δ_{q,-2}−δ_{q,-1}+δ_{q,2}+δ_{q,3}≡(0, . . . , −1,−1,0,0,1,1, . . . , 0)^{T} as the second filter to perform edge detection. Here, we placed two consecutive zeros at q₀ and q₁ so that the kernel contains an even number of elements, which, as previously discussed, prevents the output from showing additional noisy behavior for even j.

For the input signal, an ideal sequence of window functions of different widths and spacings is provided. Such an input serves as an enlightening test scenario to understand any potential issues and advantages for each filter, the outcome of which is depicted in FIG. 7. In the latter, one can identify a relatively large window at the left of the input of FIG. 7. The u^{(j-1)} filter is capable of identifying the edges of the signal in a clean way. Although a double-box filter accomplishes the same task, the signal becomes noisier than the first filter. The situation changes in the intermediate region of the signal, where a narrow window appears. As previously described, the first filter fails to detect the edges, whereas the double-box filter does the job. Lastly, on the right side of the signal, the first filter spikes up at the outer edges of the signal and fails to detect the inner sides.

Thus, the double-box filter provides a more accurate detection scheme but induces extra noise into the output, which is a less-than-ideal scenario when dealing with more complex input signals, such as those with background noise. To verify this, let us consider a simple window signal exposed to a background Gaussian noise with a standard deviation σ=0.3. This noisy signal can be used to test the edge detection capacities using the previously introduced two filters. The results are shown in FIG. 8, where it is clear that the u^{(j-1)} filter does a better job suppressing the background noise and finding the edges of the clean signal. The even and odd pooling at the output improves the signal quality by removing the oscillatory behavior between consecutive even and odd ports, as seen in FIG. 8. The double-box filter produces an output indistinguishable from noise (see the upper-center inset of FIG. 8), an issue not fixed with the abovementioned pooling scheme. As a possible workaround to this problem, one can consider a wider double-box kernel, namely, k^{(d-C)}:=, . . . , 1, 1, 1, 1, 0, 0, 1, 1, 1, 1, . . . , 0)^{T}. The width of such a modified double-box filter can be steered in order to control the effectiveness of detecting peaked and noisy signals.

The reliability of the fractional convolution device can be evaluated by a wave simulation of the architecture described above. To this end, the beam-envelope formulation is used in COMSOL Multiphysics to speed up the design and computational time of the architecture, valid for electromagnetic waves whose oscillations in the propagation direction are much faster than those in the perpendicular direction. In this regime, electric fields take the form \vec{E}(\vec{r};t)=\vec{E}(\vec{r}_{T}) e^{-i(wt+\vec{k}·\vec{r}}^{_{L}}⁾, with \vec{r}_{T} and \vec{r}_{L} being the position vectors on the transverse and longitudinal directions of propagation, respectively. Furthermore, \vec{k}=β\hat{r}_{L}, is the propagation vector and β the corresponding propagation constant. Here, we consider a two-dimensional setup in which the direction of propagation is fixed at î so that the transverse electric field takes the form \vec{E}(\vec{r})=E(y)\hat{Z}.

In some embodiments, a silicon-on-insulator (SOI) platform is used to develop the proposed architecture. To achieve this, consider a 1550 nm infrared source propagating through a silicon (Si) waveguide (core). The core has a transverse square shape with 200 nm of width and a refractive index of ncore=3.48, which renders an effective index of 2.85 for the effective two-dimensional model. The core is surrounded by a fused silica cladding (SiO2) with a refractive index of ncla=1.47. This leads to a unique guided mode with propagation constant β=8.9151×106 rad/m. The guided mode has a maximum point at the core center that varies slowly within the core and decays exponentially throughout the cladding. To illustrate the complete convolution architecture, a device is provided with N=9 channels (j=4), where the waveguides corresponding to the channels p=−1, 0, +1 are uniformly separated by 0.63 nm, whereas the subsequent waveguides are separated by 637.99 nm (p_1, 2 and p=−1,−2), 657.13 nm (p=2, 3 and p=−2,−3), and 700.11 nm (p=3, 4 and p=−3,−4). This separation ensures the coupling strengths required for the Jx lattice so that \tilde{k}L=π/2 is fulfilled for the lattice length L=139.32 μm, which is the required length to perform the DFrFT, and L=419.97 μm for the inverse DFrFT. The coupling length and separation of each 50:50 directional coupler are 29.35 μm and 630 nm, respectively. Passive phase shifters, such as small bends, are placed before any bend to compensate for any deviation in the optical path, whereas active phase shifters are placed after every 50:50 directional coupler to modulate phase and amplitude throughout the MZI.

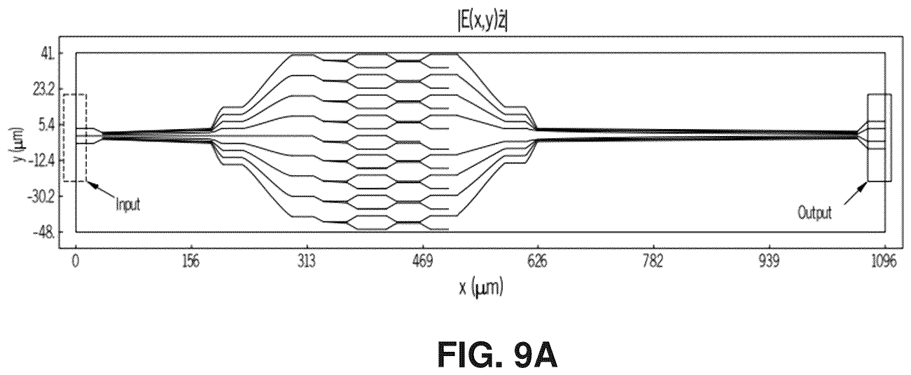

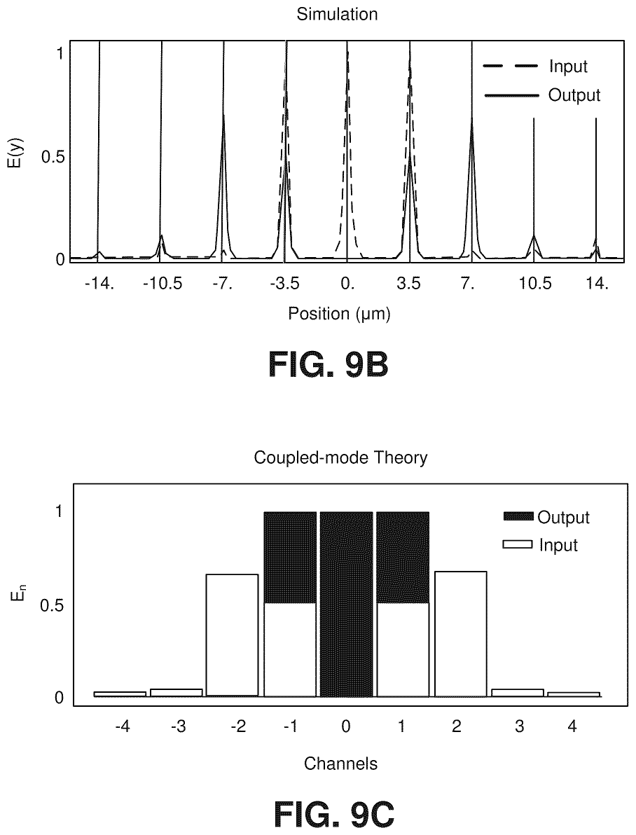

Although phase shifters can be deployed through conventional thermo-optical effects, phase-change materials have opened the possibility for even more compact phase shifters. Particularly, an implementation based on Sb₂Se₃ has shown to achieve a phase shift of approximately π/11 rads/μm for a 1550 nm source, for example, described in C. Ríos, Q. Du, Y. Zhang, et al., “Ultra-compact nonvolatile phase shifter based on electrically reprogrammable transparent phase change materials,” PhotoniX 3, 26 (2022), the entirety of which is incorporated by reference herein. The ongoing simulations use the latter solution for the active phase elements to steer the properties of the MZI. From the previous considerations, and after including proper bends to connect the Jx lattices with the MZI elements and the phase shifters, the total dimension of the optical device becomes 1096 μm×89 μm. Clearly, this does not include the packaging, but it provides a reasonable estimation of the device size. As a particular example, the edge detection scheme is considered in these simulations, where the window signal f=(0,0,0,1,1,1,0,0,0)^{T} is injected at the input and the kernel k^{(C)}=(0,0,−1,−1,0,1,1,0,0)” is used as the convolution filter. Recall that the phase shifters of the MZI array are tuned so that they render the DFrFT of k^{(C)} which in this case becomes K^{(C)}=(−0.935i, −0.935i, −0.353i, −0.353i, 0.353i, 0.353i, 0.935i, 0.935i). Because of the small number of channels, the double-box filter has been used instead of the u^{(j-1)} filter. As discussed earlier, the latter filter is unsuitable for narrow input signals, such as the one considered here. The simulated propagation of the electric field modulus throughout the architecture is depicted in FIG. 9A. The respective input and output electric field moduli are in FIG. 9B, where the gray shaded area denotes the location of the waveguide core. Clearly, the simulation output reveals the two expected peaks, one next to each edge of the input signal, thus performing the desired edge detection. Furthermore, FIG. 9C portrays the theoretical results obtained from coupled-mode theory, from which one can notice a good agreement between the simulated and theoretical results.

The previous predictions based on coupled-mode theory are further assessed through full-wave FDTD simulations, which provide a more realistic scenario of the expected results. The simulated propagation of the electric field modulus is depicted in FIG. 9A for N=9. Bézier arms are used to connect the waveguide arrays to the phase shifter layers. The respective input and output normalized intensities are shown in FIG. 9B, where the gray shaded area denotes the location of the waveguide core. Clearly, the simulation output reveals the two expected peaks, one next to each edge of the input signal, thus performing the desired edge detection. For comparison, FIG. 9C portrays the theoretical results obtained from coupled-mode theory, from which a good agreement between the simulated and theoretical results can be observed.

The architecture described in accordance with embodiments herein was tested for different filtering processes and proved reliable even for noisy signals. Still, errors may appear during the manufacturing process of the Jx lattice, rendering waveguide arrays that deviate from the ideal one described by the Hamiltonian H. Given the nature of the unpredicted errors, a new lattice model can be provided accounting for such effects through added uniform random noise. To this new perturbed lattice Hamiltonian [symbol] (δ)= [symbol] +δ [symbol] is introduces with δ>0 a strength parameter and [symbol] a(2j+1)×(2j+1) symmetric matrix whose components [symbol] _{p,q} are taken from the uniform distribution with unit mean. In this form, the wave propagation is still ruled by a lossless process, characterized by the unitary evolution operator [symbol] =e^{-iα} [symbol] ^{(δ)}. Since the DFrFT of the convolutional kernel k is programmed through the MZI array, we only require the implementation of two Jx lattices, for example, shown in FIG. 2 and thus defects are only considered in such layers. For each one of the latter, we consider a different perturbation matrix R so that defects may not be the same. Recall that the second DFrFT layer has a different length (2π−a), corresponding to the inverse DFrFT operation. Following the same treatment as in previous sections, we fix α=π/2.

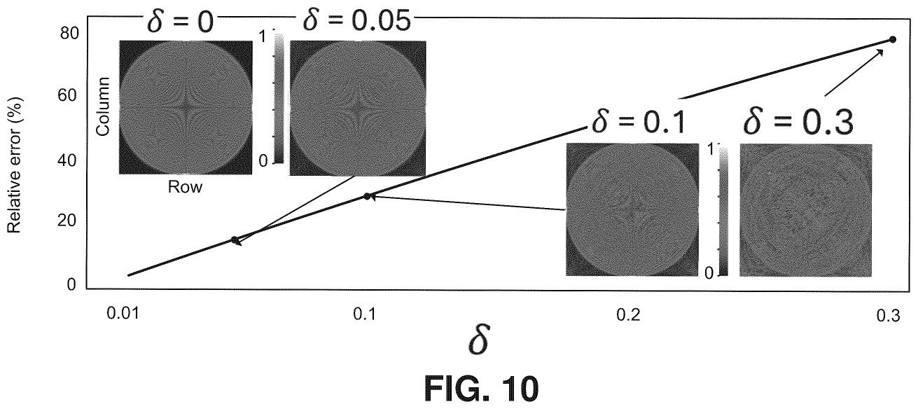

In order to understand the influence of the perturbation R, we compute the relative error

$$E ( δ ) := {‖ \tilde{𝔾} ( \frac{π}{2} ; δ ) - 𝔾 ( \frac{π}{2} ) ‖}_{F} / {‖ 𝔾 ( \frac{π}{2} ) ‖}_{F} ,$$

where ∥ [symbol] ∥F:=√tr( [symbol] [symbol] ^{†}) stands for the Frobenius norm of the complex matrix [symbol] . The latter allows quantifying any deviation from the original DFrFT as a function of the perturbation strength δ. To avoid any misleading behavior, we compute 100 perturbed DFrFT matrices [symbol] (π/2;δ) and their corresponding relative percent error E(δ)×100% for each δ; then, the mean and standard deviation per δ is computed. The results are shown in FIG. 10, showing the mean (line) and standard deviation (shaded area) of the relative percent error E(δ)×100%, for a set of 100 randomly generated perturbed DFrFT matrices [symbol] (π/2;δ) per value of δ. The insets in FIG. 10. depict the matrix modulus of a random sample out of the set of 100 random matrices for δ=0.05, 0.1, 0.3. In FIG. 10, it can be seen that a relative error of 14.7% is reached for δ=0.05, whereas the error rises to 28% and 80% for δ=0.1 and δ=0.3, respectively. A graphic visualization of the DFrFT and its perturbed counterparts is presented as the matrix modulus

$$\vert \tilde{𝔾} ( \frac{π}{2} ; δ ) \vert$$

in the insets of FIG. 10. These figures reveal a mild distortion of the DFrFT for δ=0.05 and δ=0.1, and an indistinct form for δ=0.3. We thus should expect similar results for relative errors up to approximately 28% (δ≈0.1).

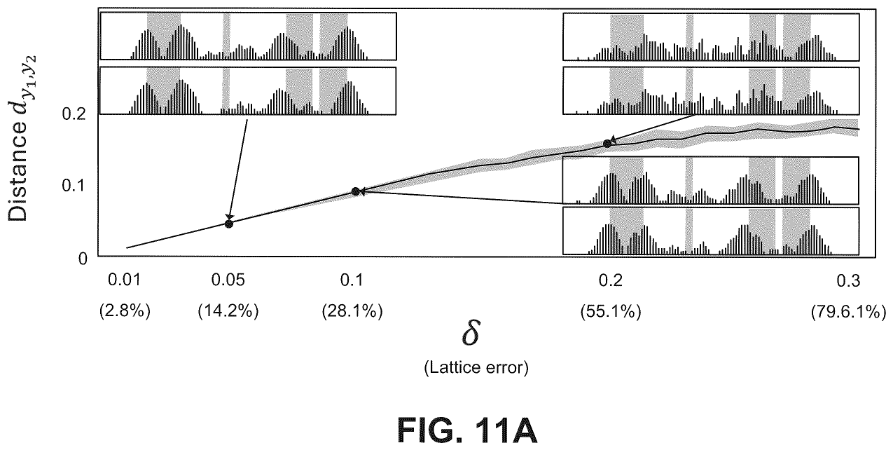

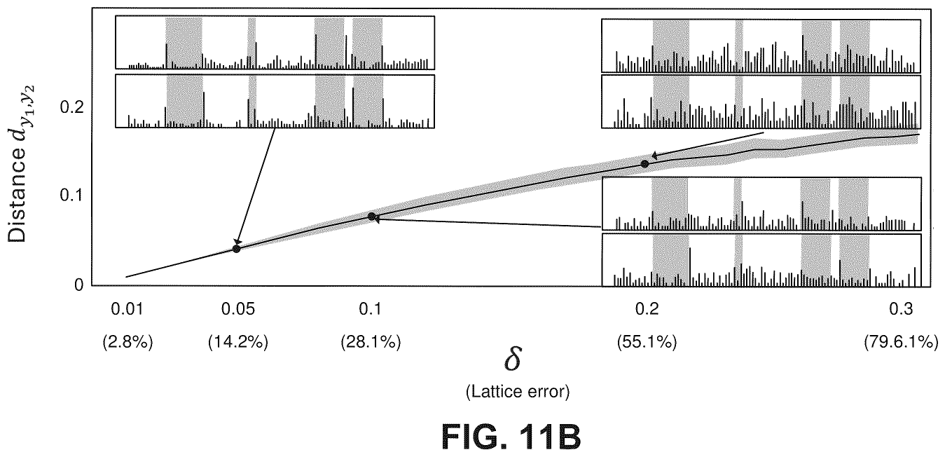

In some embodiments, effects of the lattice defects can be determined on the edge detection scheme using both the u^{(j-1)} and doublebox filters. Since the output of the perturbed convolution and the ideal convolution vectors are in [symbol] ^{2j+1}, the distance function Eq. (3) can be used as a comparison benchmark, with y₁ and y₂ the perturbed and unperturbed outputs, respectively. A set of 100 random matrices [symbol] (π/2;δ) and another one for [symbol] (3π/2;δ) are generated so that multiple edge detection operations can be computed for each δ. The corresponding distance is computed for every output with respect to the unperturbed one; the mean and standard deviations for each δ are shown. The distance using both filters leads to similar results, where it can be noticed that lattice errors of 14.2% do not produce any relevant change in the edge detection for both filters [see insets in FIGS. 11A and 11B].

For lattice errors around 28.1%, the filter u^{(j-1)} is still performing well, whereas the double-box filter misses some of the edges during the detection scheme. In the latter, the even and odd pooling allows for a cleaner output where the edges are properly identified. This highlights the relevance of such pooling operations in this convolution architecture in the presence of lattice defects. In turn, the output is indistinct for an error of 55.1%, where the pooling operations also fail to extract any relevant information.

In summary, a DFrFT based on the Jx photonic lattice is a valuable resource for constructing an adequate convolution architecture, in accordance with embodiments of the present inventive concept. This choice was not fortuitous as the asymptotic behavior for large channel numbers reveals that such a lattice asymptotically reproduced the continuous FT operation. Interestingly, the same lattice can be used as a source to generate convolution kernels that can be later used in the convolution process. So far, the j-th and (j−1)-th modes have proved to be suitable kernels to produce Gaussian like smoothing and edge detection tasks, respectively.

In some embodiments, a single delta kernel was used in the middle channel of the convolution kernel, which, in the conventional convolution, leaves the input invariant. To quantify any difference, the distance was computed between the lattice eigenmodes at the input and their respective convolution output, which showed that eigenmodes around n=0 are more prompt to deviate at the output. In turn, eigenmodes close to the edges are less affected, and their deviation decreases when a larger number of channels are considered.

For more general signals without any particular symmetry, the output decomposes into even and odd channel outputs

$${( f {*}_{\frac{π}{2}} k )}_{2 q} and {( f {*}_{\frac{π}{2}} k )}_{2 q + 1} ,$$

respectively. The latter can be written entirely in terms of Cm and the basic elements u (m) (see the Convolution Expansion description below), from which one notices that even and odd channels at the output differ by an additive term that breaks any potential continuity contiguous channels. This explains the wavy behavior of the convolution when noisy signals are considered, such as those depicted in FIG. 6 and FIG. 8, and also justifies the introduction of even and odd pooling as a mechanism to clean the convolution output.

The architecture in accordance with embodiments has shown to be a reliable source for performing edge detection tasks for both clean and noisy inputs. This is particularly achieved by either exploiting one of the lattice eigenmodes u^{(j-1)} as an edge-detection filter or using the conventional double-box filter. The former one suits better for signals whose width is at least of the order of the eigenmode u^{(j)}, whereas the double-box filter works better for narrower signals. This fact is further tested by computing wave simulations of the full architecture, which reveals a good match with the theoretical predictions. The simulation design reveals some challenges in achieving the ideal Jx lattice, mainly due to the preliminary coupling between the waveguides around the bends connecting the channel cross-talk. Numerical data from the simulation suggest that such undesired coupling occurs around 1-2 μm prior to the array end points for an initial waveguide separation of 630 nm in the central channels. This separation has been chosen as the total propagation length to achieve the DFrFT at 139.32 μm. This is much larger than the distance where the channel cross-talk occurs, and any potential deviations from the ideal behavior do not compromise the desired functionality.

In some embodiments, the convolutional architecture has shown resilience due to defects on the Jx lattice. This was elucidated by adding a random and symmetric interaction to the lattice Hamiltonian so that the wave evolution through the lattice is still unitary despite the included random defects. The intensity of such defects is controlled by employing a strength parameter δ. The error induced in the wave evolution is relatively large even for δ≈0.1. This was further illustrated by performing the edge detection operation, which is still reliable with lattice errors of up to 28%. Thus, the coupling parameters kₚ are allowed to have mild deviations from their exact values, and the architecture is still expected to perform the convolution task.

A convolution photonic design has the potential to operate passively for task-specific convolution kernels. This implies that for a specific kernel filter, optical bends can be used instead of active phase shifters to produce the required phase changes and pre-program the necessary kernel. This results in a device that consumes no external power and can process any number of signals to extract the corresponding feature pre-programmed in the kernel.

For completeness, one can alternatively construct a convolution scheme based on circulant convolutions. The convolution kernel has been replaced by a circulant matrix that multiplies the input signal, where the circulant matrix factorizes in terms of the DFT. Such an approach can be easily modified and implemented using the evolution operator, see Eq. (2) above, proved in the Exact Circulant Convolution section below. Nevertheless, the implementation of the latter solution as a photonic architecture is unclear, and the approach discussed throughout this work seems more adequate from a practical point of view, because it is possible to identify each of the matrices with optical elements.

### Convolution Expansion

In some embodiments, the output at the convolution device can be explicitly computed for any input signal and convolution kernel to explain the oscillatory-like behavior observed in FIG. 6 and FIG. 8, and thus the use of the even and odd pooling operations. This is clearly seen if one rewrites the input signal using the photonic Jx lattice eigenmodes and the kernel in terms of delta-kicks. This is indeed a legitimate operation as different orthonormal bases can be transformed through unitary operations, and the result is independent of the basis. Thus, the most general form f= [symbol] fₗu( [symbol] ) for the input signal and k=Σₛkₛe^{(s)} for the kernel is considered, with e^{(s)} the s-th canonical unit vector in [symbol] ^{N}. Although the latter expansion of the signal and kernel is not unique, it is useful and straightforward to explain the behavior of the fractional convolution.

In accordance with embodiments of the present inventive concept, the discrete fractional Fourier transform of the signal f=u( [symbol] ) and kernel k=e^{(s)} renders the transformed components

$${F}_{p}^{( ℓ )} ( α = \frac{π}{2} ) ≡ {F}_{p}^{( ℓ )} = {( - i )}^{ℓ} {u}_{p}^{( ℓ )} and {K}_{p}^{( s )} ( α = \frac{π}{2} ) ≡ {K}_{p}^{( s )} = {( - i )}^{( s - p )} {u}_{p}^{( s )} ,$$

respectively. The convolution is then determined from Eq. (1) and by computing the inverse fractional Fourier transform of (F⊙K)ₚ=Fₚ⁽ [symbol] ⁾Kₚ^{(s)}. This is simplified by recalling the identity

$${𝔾}_{p , q} ( \frac{π}{2} ) = {( - i )}^{q - p} {u}_{p}^{( q )} ,$$

for example, described in S. Weimann, et. al. “Implementation of quantum and classical discrete Fractional Fourier transforms,” incorporated by reference above. The latter can be cast into the form

$${𝔾}_{q , p} ( - \frac{π}{2} ) = {( - i )}^{p - q} {u}_{p}^{( q )} ,$$

where the identity uₛ⁽ [symbol] ⁾=(−1)^{s-r}uᵣ^{(s)} was used. The straightforward calculations show that

$${( {u}^{( ℓ )} {*}_{\frac{π}{2}} {e}^{( s )} )}_{q} = {μ}_{ℓ , s}^{( q )} + {σ}_{ℓ , s}^{( q )} ,$$

$$where$$

$${μ}_{ℓ , s}^{( q )} = {( - i )}^{q + ℓ + s} {u}_{0}^{( q )} {u}_{0}^{( ℓ )} {u}_{0}^{( s )} ,$$

$${σ}_{ℓ , s}^{( q )} = {( - i )}^{q + ℓ + s} {\sum }_{p = 1}^{j} ( {u}_{p}^{( q )} {u}_{p}^{( ℓ )} {u}_{p}^{( s )} + {u}_{- p}^{( q )} {u}_{- p}^{( ℓ )} {u}_{- p}^{( s )} )$$

Since the photonic lattice eigenmodes are parity symmetric,

$${u}_{- q}^{( n )} = {( - 1 )}^{n} {u}_{q}^{( n )}$$

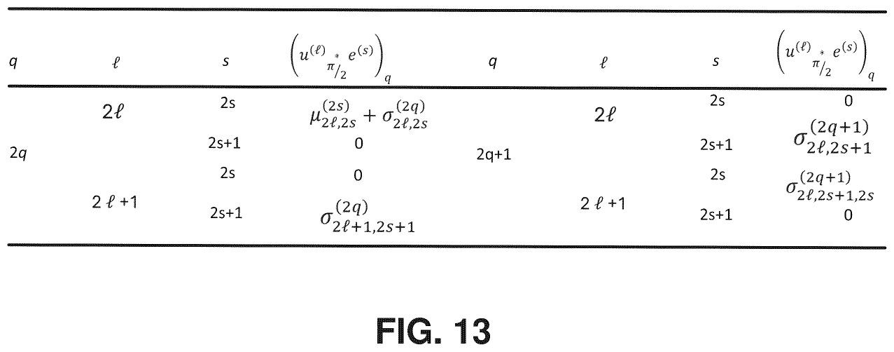

for even j, the function [symbol] survives only for even q, [symbol] , and s, and vanishes otherwise. Likewise, [symbol] cancels out according to the parity of the indexes q, [symbol] , and s, as summarized in FIG. 13. Consequently, the convolution [Eq. (1)] produces an output only on the even or odd channels, as depicted in the cases portrayed in FIGS. 3A-3D.

In some embodiments, the latter results can be expanded and use them for a general input signal and convolution kernel. The output at the convolution device takes the forms

$${( f {*}_{\frac{π}{2}} k )}_{2 q} = {\sum }_{ℓ = - j / 2}^{j / 2} {\sum }_{s = - j / 2}^{j / 2} {f}_{2 ℓ} {k}_{2 s} ( {μ}_{2 ℓ , 2 s}^{( 2 q )} + {σ}_{2 ℓ , 2 s}^{( 2 q )} ) + {\sum }_{ℓ = - ( j - 1 ) / 2}^{( j - 1 ) / 2} {\sum }_{s = - ( j - 1 ) / 2}^{( j - 1 ) / 2} {f}_{2 ℓ + 1} {k}_{2 s + 1} {σ}_{2 ℓ + 1 , 2 s + 1}^{( 2 q )} ,$$

$${( f {*}_{\frac{π}{2}} k )}_{2 q + 1} = {\sum }_{ℓ = - j / 2}^{j / 2} {\sum }_{s = - ( j - 1 ) / 2}^{( j - 1 ) / 2} {f}_{2 ℓ + 1} {k}_{2 s + 1} {σ}_{2 ℓ , 2 s + 1}^{( 2 q + 1 )} + {\sum }_{ℓ = - ( j - 1 ) / 2}^{( j - 1 ) / 2} {\sum }_{s = - j / 2}^{j / 2} {f}_{2 ℓ + 1} {k}_{2 s} {σ}_{2 ℓ + 1 , 2 s}^{( 2 q + 1 )} ,$$

for even and odd channels, respectively.

From the explicit form of the eigenmodes u_{q}⁽ⁿ⁾≡(−1)^{q-n}uₙ^{(q)}, it can be seen that theses equations define continuous functions separately for q ∈ [symbol] . The same behavior is expected for discrete q for each of those functions. When considering the total output, it is noticed that the even output has an additive term [symbol] that depends on q and it is not present in the odd output. This term produces a sharp jump when transiting between even and odd channels when the general input signal does not have any parity symmetry, as depicted in the convolution examples presented herein. In turn, by suppressing the total output into its even and odd channels, the oscillatory-like behavior is eliminated and only the relevant components of these equations are preserved, which are each smooth in the continuous case. This justifies the smooth behavior at the output when using the even and odd pooling introduced in the main text.

### EXACT CIRCULANT CONVOLUTION THROUGH THE DERFT

The convolution described above is the most immediate scheme that can be implemented by simply using photonic Jx lattices of different lengths. This converges to the continuous convolution in the proper limit j→∞. Still, one can rewrite the conventional convolution matrix in terms of the Jx operator by exact means. Although the latter provides no insight into physical implementations, it is worth discussing the method here.

The convolution operation for two vectors f and k writes as (f*k)_{q}=Σ_{q′=j}^{j}f_{q}k_{q-q}, whereas the circulant convolution (defined for cyclic functions k_{q±N}=k_{q}) can be written as (f*k)=Cf, where C is the circulant matrix

$$C = ( \begin{matrix}{k}_{1} & {k}_{N} & {k}_{N - 1} & … & {k}_{2} \\ {k}_{2} & {k}_{1} & {k}_{N} & … & {k}_{3} \\ {k}_{3} & {k}_{2} & {k}_{1} & … & {k}_{4} \\ ⋮ & ⋮ & ⋮ & ⋱ & ⋮ \\ {k}_{N} & {k}_{N - 1} & {k}_{N - 2} & … & {k}_{1}\end{matrix} ) .$$

The latter can be rewritten by using the fact that any circulant matrix can be decomposed as the product of DFT matrices and a diagonal matrix, the components of which are the components of the DFT of the kernel in question. That is, C=FDF^{†}, with F^{p,q}=N^{-1/2}e^{-2πi pq/N} the DFT matrix components and D=diag (k₁, . . . , k_{N}), with [symbol] [k]ₚ=Kₚ the DFT of k.

The DFT matrix F can be written in terms of the [symbol] (ϕ/2) matrix of the photonic lattice Jx as follows. First, the DFT matrix has the set of degenerate eigenvalues {1,−1, i,−i} for N>4, where the exact degeneracy depends on whether N=4m, 4m+1, 4m+2, 4m+3 for some positive integer m, described in B. Dickinson and K. Steiglitz, “Eigenvectors and functions of the discrete Fourier transform,” IEEE Trans. Acoust. Speech Signal Process. 30, 25-31 (1982) the entirety of which is incorporated by reference herein. Despite this degeneracy, it is possible to find an orthonormal set of eigenvectors {V⁽ⁿ⁾}ₙ₌₁^{N} that is complete in the vector space [symbol] ^{N}. This set is usually computed by identifying a matrix that commutes with F. Such a basis can always be arranged in such a way that the spectral decomposition F=Σₙ₌₁^{N}(−i)ⁿV⁽ⁿ⁾[V⁽ⁿ⁾]^{†} is allowed. Likewise, the set of eigenvectors of the DFrDFT, {u⁽ⁿ⁾}_{n=1′}^{N} also forms an orthonormal in [symbol] ^{N}. Thus, one can move from one basis to the other through the unitary operation V⁽ⁿ⁾= [symbol] u⁽ⁿ⁾, where [symbol] =Σₙ₌₁^{N}V⁽ⁿ⁾[u⁽ⁿ⁾]^{†}. In this form, the mapping between the basis combined with the spectral decomposition of the DFT and DFrDFT allows rewriting the circulant convolution matrix in terms of the DFrFT through

$$C = F D {F}^{†} = 𝒪𝔾 ( \frac{π}{2} ) \tilde{D} 𝔾 ( - \frac{π}{2} ) 𝒪 , \tilde{D} = 𝒪 D {𝒪}^{†} .$$

The new representation in terms of the DFrFT requires the specific lattice length α=π/2 to match the eigenvalues of the lattice with those of the DFT. The convolution matrix is now written in terms of the unitary operator [symbol] and the non-diagonal matrix \tilde{D}. The conventional convolution matrix is a particular case of Toeplitz matrices, which are asymptotically approximated for large matrices through circulant matrices. Thus, the circulant convolution and the convolution matrix in the previous equation approximate the conventional convolution for large N.

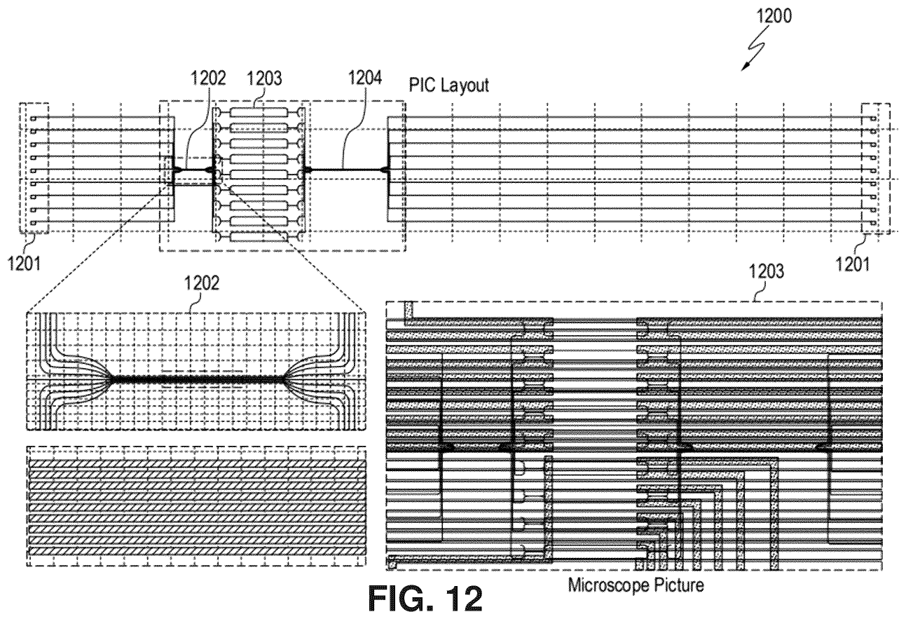

FIG. 12 is a schematic view of a photonic integrated circuit (PIC) layout 1200, in accordance with some embodiments. In some embodiments, the PIC layout 1200 is used for manufacturing purposes through open-access silicon foundries. The layout depicts the physical waveguide array 1206 performing the DFrFT 1202 on the input signal. This also shows a layer of Mach-Zehnder interferometers encoding the transformed kernel and the point-wise operation with the transformed input signal in a single embodiment 1203. The inverse DFrFT is performed through the waveguide array 1204. For light coupling in and out, an array of grating couplers 1201 is attached as the layout input and output ports. This design effectively allows the light transformation according to the theory of the invention as an integrated photonic circuit. The material platform used for the design and fabrication is silicon-on-silica, which in some embodiments comprises single-mode silicon waveguides with 500 nm of width and 220 nm of height, buried in a silica cladding. In some embodiments, the phase shifters are based on thermo-optical solutions, implemented using Ti/W alloy metal heaters and connected to the probing pads using bi-layer TiW/Al electrical traces. In some embodiments, the probing pads are wire bonded to a PCB for electrical access and manipulation, allowing the required phase tunability. This configuration is not restricted to a current silicon-on-silica platform, and it can be deployed in other material platforms such as silicon-nitride and lithium-niobate.

In some embodiments, the systems, devices, and methods described herein can serve as a fundamental component for optical convolutional neural networks and their variants such as diffusion-convolutional network. The convolution can identify specific features in the input image based on the filter utilized, which can be utilized as training inputs for tasks like image and pattern recognition that need multiple feature maps. Also, the use of optical convolution devices can lead to more advanced optical processing devices, especially in the field of image processing. By employing wavelength division demultiplexing, a two-dimensional image can be flattened into one-dimensional data strings, processed through the convolutional device presented here, and then restored into a two-dimensional image with a multiplexer process.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims are not limited to the particular embodiments disclosed, but that the claims will include all embodiments falling within the scope and spirit of the appended claims.

What is claimed is:

1. A photonic circuit, comprising:
a first waveguide lattice having a first length for providing a discrete fractional Fourier transform operation on the input optical signal;
a programmable modular array of tunable phase shifters for providing the fractional Fourier transform of the kernel and performing a point-wise product on the previously transformed input optical signal;
a second wavelength lattice having a second length for providing an inverse discrete fractional Fourier transform operation on the previous processed optical signal;
a processor that determines a convolved output of the input signal and the convolution kernel.

2. The photonic circuit of claim 1, wherein the first waveguide lattice includes a photonic Jx lattice to perform the discrete fractional Fourier transform operation.

3. The photonic circuit of claim 1, wherein the first waveguide lattice and the second waveguide lattice include a plurality of non-uniform spaced waveguides that render an equally spaced supermode spectrum.

4. The photonic circuit of claim 1, wherein the programmable modular array is constructed and arranged as an interlaced configuration so that a required fractional convolution operation is performed.

5. The photonic circuit of claim 1, wherein the discrete fractional Fourier transformation performed one the at least one of the convolution kernels and the input signal has a first predetermined order (a) defined by a lattice length through a propagation direction, and the final discrete fractional Fourier transformation layer has a second order (2π-α).

6. The photonic circuit of claim 1, wherein the photonic circuit is implemented in a displacement filter.

7. The photonic circuit of claim 1, wherein the photonic circuit is implemented in a smoothing filter.

8. The photonic circuit of claim 1, wherein the photonic circuit is implemented in an edge-detection filter.

9. A lens-free device for performing discrete fractional Fourier transformation (DFrFT), the lens-free device comprising a first waveguide array with a length of \tilde{k}π/2, that is optically connected to a programmable array of Mach-Zehnder interferometers (MZI), each MZI having two 50:50 couplers and two programmable phase shifters, each MZI interferometer optically connected to a second waveguide array with a length of 3\tilde{k}π/2.

10. The lens-free device of claim 9, wherein the first waveguide array the physical waveguide array 1206 performs the DFrFT on an input signal, and wherein the MZIs encode a transformed kernel, which is processed with the input signal in a point-wise operation.

11. The lens-free device of claim 9, further comprising grating couplers attached as input and output ports for performing light coupling operations.

12. The lens-free device of claim 9, wherein the first waveguide array includes a photonic Jx lattice to perform the DFrFT operation.

13. The lens-free device of claim 9, wherein the lens-free device is implemented in a displacement filter.

14. The lens-free device of claim 9, wherein the lens-free device is implemented in a smoothing filter.

15. The lens-free device of claim 9, wherein the lens-free device circuit is implemented in an edge-detection filter.

16. A method, comprising:
receiving an input signal at a first input of a system;
receiving a convolution kernel at a second input of the system;
producing a discrete fractional Fourier transformation of at least one of the convolution kernel and the input signal; and
generating a convolved output at an output of the system.

17. The method of claim 16, further comprising:
performing a point-wise multiplication operation of the input signal and the convolution kernel; and
outputting an output of the multiplication operation to a final discrete fractional Fourier transformation layer to generate a convolved output.

18. The method of claim 16, wherein the discrete fractional Fourier transformation performed one the at least one of the convolution kernel and the input signal has a first predetermined order (a) defined by a lattice length through a propagation direction, and the final discrete fractional Fourier transformation layer has a second order (2π-α).
